(19) United States
(12) Patent Application Publication
(10) Pub. No.: US 2024/0332641 A1
(43) Pub. Date: Oct. 3, 2024

(54) POSITIVE ELECTRODE PIECE AND BATTERY

(71) Applicant: ZHUHAI COSMX BATTERY CO., LTD., Zhuhai (CN)

(72) Inventors: Jiajiang ZENG, Zhuhai (CN); Suli LI, Zhuhai (CN); Jianwen LIU, Zhuhai (CN)

(21) Appl. No.: 18/737,894

(22) Filed: Jun. 7, 2024

Related U.S. Application Data
(63) Continuation of application No. PCT/CN2023/079927, filed on Mar. 6, 2023.

(30) Foreign Application Priority Data
Mar. 15, 2022 (CN) 202210253582.9

(51) Int. Cl. H01M 10/42; H01M 4/02; H01M 4/131; H01M 4/525; H01M 4/66

(52) U.S. Cl. CPC H01M 10/4235; H01M 4/131; H01M 4/525; H01M 4/667; H01M 2004/028

(57) ABSTRACT

The present application discloses a positive electrode and a battery, which can solve safety problems faced by a high-energy-density battery, and prevent the problems that an initial direct-current internal resistance (DCIR) of the battery is too large, an increase change rate of the DCIR is large and a cycle performance deteriorates during cycle process. The present application provides a positive electrode piece, including a positive electrode current collector, a safety layer and an active substance layer, where the safety layer is arranged on a surface of the positive electrode current collector; the active substance layer is arranged on a surface of the safety layer; the safety layer and the active substance layer each contain Co and Al, where a mass ratio of a total amount of Co to a total amount of Al in the safety layer and the active substance layer is (12-85):1.

### CROSS-REFERENCE TO RELATED APPLICATIONS

This application is a continuation of International Application No. PCT/CN2023/079927, filed on Mar. 6, 2023, which claims priority to Chinese Patent Application No. 202210253582.9, filed on Mar. 15, 2022. The disclosures of the aforementioned applications are hereby incorporated by reference in their entireties.

### TECHNICAL FIELD

This application relates to the technical field of battery preparation, and specifically to a positive electrode piece and a battery.

### BACKGROUND

Power batteries and high-voltage digital batteries are currently developing rapidly and are widely used in 3C consumption digital product fields such as mobile phones, laptops, tablets, and Bluetooth small batteries etc., and electric vehicle fields. Whether in the digital product fields or power fields, the requirements for battery safety performance become higher and higher. The safety performance and cycle performance of the battery are two important indicators of battery performance.

At present, in terms of safety performance enhancement and improvement, a undercoating safety layer with a high resistivity is generally added between an active substance coating and a current collector in the battery to improve the safety performance of the entire positive electrode piece.

However, in an existing battery, which adopts an undercoating mode to solve the safety problem, the undercoating safety layer often has a high resistivity, resulting in a high initial direct-current internal resistance of a designed battery or a large increase rate of direct-current internal resistance of the battery during cycle process, thus affecting the cycle performance of the battery.

### SUMMARY

In order to solve the above-mentioned problems in the prior art, that is, to solve the safety problem faced by a high-energy-density battery, and to avoid the problems of a large initial direct-current internal resistance of the battery, a large increase change rate of the direct-current internal resistance (DCIR) during cycle process and deterioration of cycle performance, the present application provides a positive electrode piece and battery to improve both safety performance and cycle performance.

In order to achieve the above objects, the present application provides a positive electrode piece, including a positive electrode current collector, a safety layer and an active substance layer, where the safety layer is arranged a surface of the positive electrode current collector, and the active substance layer is arranged on a surface of the safety layer;
both the safety layer and the active substance layer contain Co and Al, where a mass ratio of a total amount of Co to a total amount of Al in the safety layer and the active substance layer is (12-85):1.

The beneficial effects of the present application are: by adding Al element to the safety layer, high conductivity of Al can be used to improve the interface problem, which is caused by poor electronic conductivity, between the safety layer and the active substance layer in the positive electrode piece during cycle process, and at the same time the structural stability of the safety layer by adding Al can not only ensure the safety of the high-energy-density battery, but also further improve the battery's cycle performance and the problem of large DCIR increase change rate during cycling, that is, improving both safety performance and cycle performance.

On the basis of the above technical solution, the present application can also make the following improvements.

In the above-mentioned positive electrode piece, in an implementation, the mass ratio of the total amount of Co to the total amount of Al in the safety layer and the active substance layer is (25-65):1.

In the above positive electrode piece, in an implementation, the safety layer includes a filler, a first conductive agent and a first binder, where the filler, the first conductive agent and the first binder are mixed with each other, and the filler includes an aluminum-containing compound; and
the active substance layer includes a positive electrode active substance, a second conductive agent and a second binder, where the positive electrode active substance, the second conductive agent and the second binder are mixed with each other.

In the above-mentioned positive electrode piece, in an implementation, a thickness of the safety layer is 1-10 μm.

In the above-mentioned positive electrode piece, in an implementation, a mass fraction of the aluminum-containing compound in the safety layer is 70-96%.

In the above-mentioned positive electrode piece, in an implementation, a chemical formula of the aluminum-containing compound is Co(II)ₓ₁Co(III)ₓ₂Al_{y}O_{z}, which satisfies 2x₁+3x₂+3y=2z;
where x₁, x₂, y, z are all positive integers; and/or,
x₁ or x₂ is 0.

In the above-mentioned positive electrode piece, in an implementation, the aluminum-containing compound is Al₂Co(II)O₄ or AlCo(II) Co(III)O₄.

In the above-mentioned positive electrode piece, in an implementation, the filler further includes at least one of carbon and a cobalt oxide.

In the above-mentioned positive electrode piece, in an implementation, a mass ratio of the second conductive agent to the second binder in the active substance layer is in a range of (0.5-2):1.

The present application also provides a battery, including a negative electrode piece, a separator and the above-mentioned positive electrode piece, where the separator is disposed between the positive electrode piece and the negative electrode piece.

In the positive electrode piece and the battery provided in the present application, the battery includes a negative electrode piece, a separator and a positive electrode piece, where the separator is arranged between the positive electrode piece and the negative electrode piece, and where the positive electrode piece includes a positive electrode current collector, a safety layer and an active substance layer; the safety layer is arranged on a surface of the positive electrode current collector, and the active substance layer is arranged on a surface of the safety layer; both the safety layer and the active substance layer contain Co and Al, where a mass ratio of a total amount of Co to a total amount of Al in the safety layer and the active substance layer is (12-85):1.

Through the above arrangement, that is, by adding an aluminum-containing compound to the safety layer, high conductivity of the aluminum-containing compounds can be used to improve the interface problem, which is caused by poor electronic conductivity, between the safety layer and the active substance layer in the positive electrode piece during cycle process, and at the same time the aluminum-containing compound can be used to improve the structural stability of the safety layer, which can not only ensure the safety performance of a high-energy-density battery, but also further improve the cycle performance of the battery and the problem of large increase change rate of direct-current internal resistance (DCIR) during cycle process, that is, improving both safety performance and cycle performance.

### BRIEF DESCRIPTION OF DRAWINGS

In order to more clearly describe the technical solutions of embodiments of the present application or the technical solutions in the prior art, the following will briefly introduce the drawings that need to be used in the description of the embodiments or the prior art. Obviously, the drawings in the following description are some of embodiments of the present application. For those of ordinary skill in the art, other drawings can be obtained based on these drawings without creative effort.

FIG. 1 is a schematic structural diagram of an embodiment of a positive electrode piece of the present application.

FIG. 2 is a schematic diagram of the steps of a preparation method of a positive electrode piece of the present application.

### DESCRIPTION OF REFERENCE SIGNS

100—Positive electrode piece; 110—Positive electrode current collector; 120—Safety layer; 130—Active substance layer.

### DESCRIPTION OF EMBODIMENTS

In order to make the purpose, technical solutions and advantages of the embodiments of the present application clearer, the technical solutions of the embodiments of the present application will be clearly and completely described below with reference to the accompanying drawings of the embodiments of the present application. Obviously, the described embodiments are part of the embodiments of the present application, but not all of them. Based on the embodiments of the present application, all other embodiments obtained by those of ordinary skill in the art without creative efforts fall within the scope of protection of present application. The following embodiments and features in the embodiments may be combined with each other without conflict.

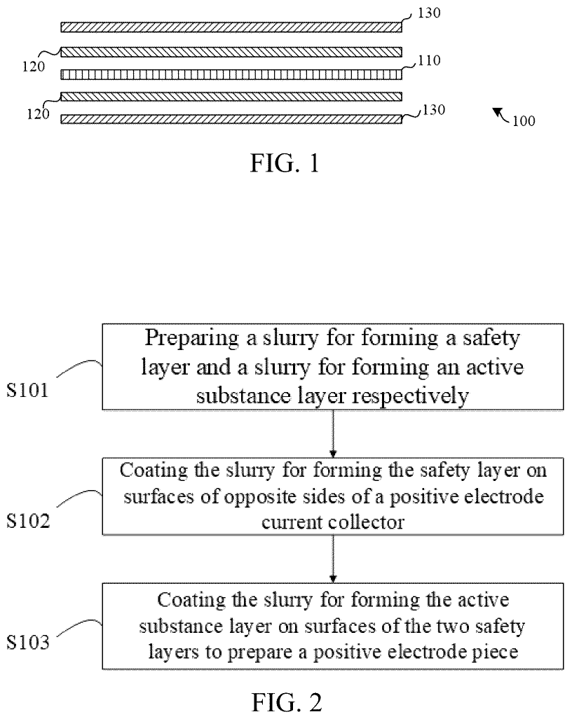

FIG. 1 is a schematic structural diagram of an embodiment of a positive electrode piece of the present application. As shown in FIG. 1, a first aspect of the present application provides a positive electrode piece 100. The positive electrode piece 100 includes a positive electrode current collector 110, a safety layer 120 and an active substance layer 130. The safety layer 120 is disposed on a surface of the positive electrode current collector 110, and the active substance layer 130 is disposed on a surface of the safety layer 120; both the safety layer 120 and the active substance layer 130 contain Co and Al, where a mass ratio of a total amount of Co to a total amount of Al is (12-85):1 in the safety layer 120 and the active substance layer 130.

In the present application, the positive electrode current collector 110 in the positive electrode piece 100, as an important component of the battery, plays a role of transmitting electrons, attaching a positive electrode active substance, and providing a certain mechanical strength to the positive electrode piece.

In some embodiments, the positive electrode current collector 110 in the positive electrode piece 100 of the present application is selected from an aluminum foil.

According to the technical solution provided by the present application, after the above-mentioned positive electrode piece 100 is applied to a battery, the cycle performance of the battery can be improved and the problem of large increase change rate of the direct-current internal resistance (DCIR) during cycle process is alleviated, so that the battery can have improved both safety performance and cycle performance, based on the reasons that: in the present application, the safety layer 120 in the positive electrode piece 100 is modified, and specifically, Al element is added to the safety layer 120, using the high conductivity of Al to alleviate the interface problem between the safety layer 120 and the active substance layer 130 in the positive electrode piece 100, which are caused by a poor electronic conductivity of electrons during cycle process. Where, after the safety layer 120 and the active substance layer 130 are separated from the positive electrode current collector 110 by a certain method, amounts of Co and Al elements in the safety layer 120 and the active substance layer 130 are detected by ICP (Inductively Coupled Plasma), where, a mass ratio of a total amount of Co to a total amount of Al in the safety layer 120 and the active substance layer 130 is (12-85):1. That is, in the safety layer 120 and the active substance layer 130, a mass proportion fraction of the total mass of Co element contained therein to the total mass of Al element contained therein is between 12 and 85.

At this time, when the mass of Co element and the mass of Al element in the safety layer 120 to the active substance layer 130 in the positive electrode piece, as detected by ICP, is maintained within a certain ratio range, it has an excellent safety performance. Therefore, the positive electrode piece 100 of the present application can improve the conductivity of the safety layer 120 and the active substance layer 130 during cycle process, and can enable the battery to have improved both safety performance and cycle performance during a long-term cycle process.

As mentioned in the above, the mass ratio of the total amount of Co to a total amount of Al is (12-85):1 in the safety layer 120 and the active substance layer 130. The reason is that: when the ratio is lower than 12, it means that the Al content in the safety layer 120 is relatively high, the safety performance is guaranteed, but its cycle performance will deteriorate and the direct-current internal resistance (DCIR) has a large increase change rate during cycle process; when the ratio is higher than 85, the safety performance of the battery cannot be ensured. In order to further ensure the safety performance of the positive electrode piece, the mass ratio of the total amount of Co to the total amount of Al in the safety layer 120 and the active substance layer 130 can be controlled to (25-65):1, that is, the mass ratio of the total mass of Co element to the total mass of Al element contained in the safety layer is 120 and the active substance layer 130 is between 25 and 65, and the positive electrode piece 100 prepared within this range not only ensures the safety of a high-energy-density battery, but also further improves the cycle performance of the battery and alleviates the problem of large increase change rate of the direct-current internal resistance (DCIR) during cycle process.

In order to further improve the structural strength of the positive electrode piece 100, the safety layer 120 in the positive electrode piece 100 of the present application includes a filler, a first conductive agent, and a first binder; the filler, the first conductive agent, and the first binder are mixed with each other, and the filler includes an aluminum-containing compound; and the active substance layer 130 includes a positive electrode active substance, a second conductive agent, and a second binder, where the positive electrode active substance, the second conductive agent, and the second binder are mixed with each other.

Specifically, a surface resistance of the positive electrode piece 100 is <3000 Ω*cm.

A mass ratio of the first binder and the first conductive agent in the safety layer 120 is 2-6:1, for example, 2:1, 3:1, 4:1, 5:1 or 6:1.

Where, compositions of the first conductive agent and the second conductive agent may be the same or different. For example, they may be independently selected from one or more of conductive carbon black, acetylene black, carbon nanotube (such as single-walled carbon nanotube, multi-walled carbon nanotube), carbon nanofiber and graphene, in an implementation, the first conductive agent and the second conductive agent may be independently selected from carbon nanotube and conductive carbon black.

Where, the compositions of the first binder and the second binder may be the same or different. For example, they may be independently selected from one or more of sodium carboxymethylcellulose, styrene butadiene latex, polytetrafluoroethylene, polyvinylidene fluoride (PVDF) and polyethylene oxide.

Referring to FIG. 1, in order to further improve a structural stability of the positive electrode piece 100, both the safety layer 120 and the active substance layer 130 have two layers; the two safety layers 120 are respectively coated on surfaces of opposite sides of the positive electrode current collector 110, and the two active substance layers 130 are respectively coated on surfaces of the two safety layers 120.

A thickness of the above-mentioned positive electrode current collector 110 is 8-12 μm; and/or a thickness of the safety layer 120 is 1-10 μm.

The thickness of the positive electrode current collector 110 in the positive electrode piece 100 of the present application is 8-12 μm. For example, the thickness of the positive electrode current collector 110 is 8 μm, 9 μm, 10 μm, 11 μm or 12 μm. Specifically, the embodiments of the present application are not limited thereto.

Where, the thickness of the safety layer 120 is 1-10 μm, in an implementation, the thickness of the safety layer 120 is 1-5 μm, for example, 1 μm, 2 μm, 3 μm, 4 μm, 5 μm, 6 μm, 7 μm, 8 μm, 9 μm or 10 μm. Where, a mass fraction of the aluminum-containing compound is 70-96% of the safety layer 120.

Further, the mass fraction of the aluminum-containing compound is 80-90% of the safety layer 120, for example, 80%, 81%, 82%, 83%, 84%, 85%, 86%, 87%, 88%, 89% or 90%.

Where, a chemical formula of the aluminum-containing compound in the safety layer 120 is Co(II)ₓ₁Co(III)ₓ₂Al_{y}O_{z}, and the chemical formula satisfies 2x₁+3x₂+3y=2z; where x₁, x₂, y, and z are all positive integers; and/or, x₁ or x₂ is 0.

The principle of aluminum-containing compounds is to blend a certain proportion of Al into Co₃O₄ compound. Since Co₃O₄ is a semiconductor material, it has a high electrical conductivity, but its structural stability is slightly worse than conventional ceramics such as Al₂O₃. In the present application, on basis that the previously adopted ceramic aluminum oxide and lithium iron phosphate are used as a undercoating to fully ensure the conductivity of Co₃O₄, a compound containing Al and Co is formed by doping a certain amount of Al, which can significantly improve the stability, so as to achieve a purpose of application; in some embodiments, the chemical formula of the aluminum-containing compound in the safety layer 120 is Al₂Co(II)O₄ or AlCo(II) Co(III)O₄.

In order to further improve the structure of the filler, the filler may include at least one of carbon and a cobalt oxide in addition to the aluminum-containing compound.

For example, the aluminum-containing compound can be used as a filler alone, or can be used as a filler after being coated with carbon, or can be used as a filler after mixing with at least one of a cobalt oxide, and an aluminum oxide. For example, the aluminum-containing compound can be mixed with Co₃O₄ or Al₂O₃ for use.

Where, the aluminum-containing compound in the safety layer 120 can be synthesized by high-temperature solid phase method, sol-gel method, solution method, etc.; raw materials used are obtained by synthesizing a cobalt-containing salt compound or a cobalt oxide and an aluminum salt compound or an aluminum oxide according to a certain stoichiometric ratio.

Where, in an implementation, the raw materials are cobalt hydroxide, cobalt oxyhydroxide, aluminum oxide, etc.

A particle diameter D₅₀ of the aluminum-containing compound in the safety layer 120 is ≤7 μm. For example, a particle diameter D₅₀ of the aluminum-containing compound is <3 μm, for example, the D₅₀ is 0.5 μm, 1 μm, or 2 μm.

In order to improve the structural strength of the active substance layer 130, a thickness of the active substance layer 130 is 50-130 μm.

In an implementation, the thickness of the active substance layer 130 is 70-90 μm, for example, 50 μm, 60 μm, 70 μm, 80 μm, 90 μm, 100 μm, 110 μm, 120 μm or 130 μm.

In addition, the positive electrode active substance in the active substance layer 130 is selected from one or more of lithium cobalt oxide, lithium nickel cobalt manganese oxide (molar content of nickel is ≥60%), lithium nickel cobalt aluminum oxide (molar content of nickel is ≥75%), which may be doped and coated.

In some embodiments, a chemical formula of the lithium cobalt oxide is LiₓMe_{1-y}M_{y}O₂, where Me=Co_{1-a-b}AlₐZ_{b}, M is one or more from Al, Mg, Ti, Zr, Co, Ni, Mn, Y, La, Sr, W, Sc, Te, and B, and can be doped or coated, Z is one or more from Y, La, Mg, Ti, Zr, Ni, Mn, Ce, Te, B, and P; 0.1<x≤1.03, 0≤y≤0.1, 0<a≤0.2, 0<b≤0.1.

Where, according to calculation, a maximum mass ratio of Co to Al in the active substance layer 130 is 87.2.

According to the present application, a mass of the positive electrode active substance in the active substance layer 130 accounts for 90-99% of a total mass of the active substance layer 130, in an implementation, the mass of the positive electrode active substance in the active substance layer 130 accounts for 96-99% of the total mass of the active substance layer 130, for example, 90%, 91%, 92%, 93%, 94%, 95%, 96%, 97%, 98%, or 99%.

In the above-mentioned positive electrode piece 100, a mass ratio of the second conductive agent to the second binder in the active substance layer 130 ranges from (0.5-2):1.

For example, the mass ratio of the second conductive agent to the second binder in the active substance layer 130 is 0.5:1, 1:1, and 2:1, which is not specifically limited.

In the above-mentioned positive electrode piece 100, a particle diameter D₅₀ of the positive electrode active substance in the active substance layer 130 is 3-18 μm.

In an implementation, the positive electrode active substance can be lithium cobalt oxide, and its particle diameter can be 10-18 μm.

FIG. 2 is a schematic diagram of steps of a preparation method of a positive electrode piece of the present application. The positive electrode piece 100 of the present application can be prepared by a preparation method shown in FIG. 2. Specifically, as shown in FIG. 2, the preparation method of the positive electrode piece mainly includes the steps as below.

S101: Preparing a slurry for forming the safety layer 120 and a slurry for forming the active substance layer 130 respectively.

During an implementation process, specifically, solid contents of the slurry for forming the safety layer 120 and the slurry forming the active substance layer 130 are 30 wt %-80 wt %.

S102: Coating the slurry for forming the safety layer 120 on surfaces of opposite sides of the positive electrode current collector 110.

During an implementation process, the coating may use extrusion coating, spray coating or other coating manner.

S103: Coating the slurry for forming the active substance layer 130 on surfaces of the two safety layers 120 to prepare the positive electrode piece 100.

Where, a surface density of the positive electrode piece 100 is 14-27 mg/cm², a porosity of the positive electrode piece 100 is 14-30%, and a compacted density of the positive electrode piece 100 is 3.0-4.3 g/cm³.

A second aspect of the present application provides a battery. The battery includes a negative electrode piece, a separator, and the positive electrode piece 100 of the first aspect. The separator is disposed between the positive electrode piece 100 and the negative electrode piece.

The battery of the present application is manufactured using a general winding and laminating process. Specifically, the positive electrode piece 100, the separator, and the negative electrode piece are wound or laminated together in sequence, and then vacuum packaged and welded with tabs, to obtain the battery.

Specifically, the negative electrode piece includes a negative electrode active substance, and the negative electrode active substance includes a graphite material or a mixture of a graphite material and a silicon material.

According to the present application, the separator may be a separator known in the art, for example a commercial battery separator known in the art.

According to the present application, the graphite material is at least one of artificial graphite, natural graphite, etc.

According to the present application, the silicon material is, for example, one or more from Si, SiC and SiOx (0<x<2).

According to the present application, the silicon material accounts for 0-20% of a total mass of the graphite material and the silicon material, in an implementation, a graphite material is used as the negative electrode active substance.

The battery of the present application also includes an electrolyte. The electrolyte may be a conventional electrolyte known in the art. A solvent in the electrolyte includes ethylene carbonate (EC), diethyl carbonate (DEC), propylene carbonate (PC), fluorinated ethylene carbonate (FEC), or the like. In addition, the electrolyte may also contain other additive. The additive T may be 4-methyl-1,3-propane sultone (4-methyl-1,2-oxathiolane 2,2-dioxide), having chemical formula shown as

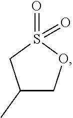

and a content of the additive accounts for 0.1-10% of a total content of the electrolyte.

The battery of the present application uses the positive electrode piece 100 of the first aspect, so it has at least all the beneficial effects as described above, which will not be repeated here.

Below, the positive electrode piece 100 and the battery of the present application are introduced in detail through specific examples.

Where, it should be noted that the experimental methods used in the following examples are conventional methods unless otherwise specified.

In addition, the compositions of PVDF glue and 5130 glue used in the following examples are polyvinylidene fluoride, which are commercially available.

### Example 1

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the resulting coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², so that a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also include a substance T as an additive, its chemical structural formula is

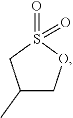

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### (1) Test Conditions and Methods for Capacity Retention Rate:

A battery is placed in an environment of 25° C. and charged and discharged under conditions of 0.7 C charge and 0.7 C discharge, a charge and discharge temperature of 25° C. and a voltage range of 3.0-4.48V.

### (2) Test Conditions and Methods for Internal Resistance Change Rate:

The battery is placed in an environment of 25° C., and is subjected to a cycle of 0.7 C charge and 0.7 C discharge, with a cut-off current being 0.05 C; DCIR is tested once for every 50 cycles: the battery is charged to 3.6V, then charged at a constant voltage, with a cut-off current of 0.05 C; and the battery is placed at a corresponding test temperature for a period of time until reaching a stable state (time for being placed is not less than 2 h); then the battery was subjected to 0.2 C discharge for 10 s to obtain a discharge end voltage, recorded as U1; then the current is switched to 1 C, and the battery was subjected to 1 C discharge for 1 s to obtain a discharge end voltage, recorded as U2, and then DCIR is calculated, with the DCIR calculation method as follows:

DCIR=(U1−U2)/(1−0.2)C).

Internal resistance change rate=Current DCIR/Initial DCIR*100%.

### (3) Test Conditions and Methods for Acupuncture:

The battery is placed under a high-temperature resistant steel needle with a diameter of Φ(3±0.5) mm (a cone angle of the needle tip is 45°-60°, and a surface of the needle is smooth and free of rust, oxide layer and oil stains), and penetrated in a direction perpendicular to the electrode piece of the battery cell at a speed of 100 mm/s±5 mm/s, where the penetration position is close to a geometric center of the penetrated surface (the steel needle stays in the battery cell). The test stops after observing for 1 hour or when a maximum temperature on surface of the battery cell drops to a temperature less than a peak temperature by 10° C. or more. The battery is recorded as pass if it does not catch fire or explode. Ten batteries are tested in each example, and a pass rate of the acupuncture test is used as an indicator to evaluate the safety performance of battery under acupuncture.

### (4) Test Conditions and Methods for Heavy Object Impact:

The battery cell is placed on a surface of a platform, a metal rod with a diameter of 15.8 mm±0.2 mm is placed horizontally on an upper surface of the geometric center of the battery cell, and a heavy object with a weight of 9.1 kg±0.1 kg is used to impact the surface of the battery cell with the metal rod placed thereon in a free-falling state from a height of 610 mm±25 mm and then an observation of 6 h is conducted. The impact test is conducted on a wide surface. One sample is only subjected to one impact test. The battery is recorded as pass if it does not catch fire or explode. Ten batteries are tested in each example, and a pass rate of the heavy object test is used as an indicator to evaluate the safety performance of the battery under heavy object impact.

### Example 2

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was put into a muffle furnace and sintered at a set sintering temperature of 870° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), and its chemical structural formula is

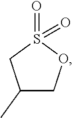

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 3

The preparation method of the positive electrode piece and battery of the present example includes the following steps:
(1) 9.2949 kg of nano-sized Co(OH)₂ particle powder and 2.9490 kg of nano-Al₂O₃ powder were weighted; the two materials were mixed in a high-speed mixer at a speed of 1500 rpm/min for 15 min; the mixture was then put into a muffle furnace and sintered at a set sintering temperature of 920° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), and its chemical structural formula is

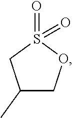

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 4

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in NMP, then a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 3.5 μm, and a surface density of the coating is 0.40 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

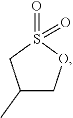

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 5

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in NMP, then a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 7.8 μm, and a surface density of the coating is 0.80 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

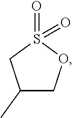

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 6

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, PVDF, and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 56 μm, and a surface density of the coating is 14.76 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

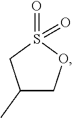

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 7

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, PVDF, and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 89 μm, and a surface density of the coating is 19.28 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

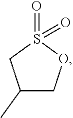

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 8

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.959}Al_{0.024}Mg_{0.012}La_{0.005}O₂, PVDF, and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

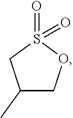

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 9

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method, conductive agent conductive carbon black SP and binder 5130 glue were mixed at a weight ratio of 85%:4.5%:10.5%, and the mixture was dispersed in N-methylpyrrolidone (NMP), then a safety layer slurry was obtained after stirring by a double planetary stirrer; the safety layer slurry was coated on surfaces of opposite sides of a positive electrode current collector 110 with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.957}Al_{0.026}Mg_{0.012}La_{0.005}O₂, PVDF, and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

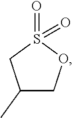

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 10

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method and commercially available Co₃O₄ powder (3.8 μm), conductive agent SP and binder 5130 glue were mixed at a weight ratio of 50%:35%:4.5%:10.5%, and the mixture was dispersed in NMP, then a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

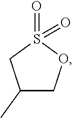

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 11

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method and commercially available nano-Al₂O₃ powder, conductive agent SP and binder 5130 glue were mixed at a weight ratio of 50%:35%:4.5%:10.5%, and the mixture was dispersed in NMP, then a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

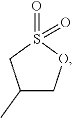

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Example 12

The preparation method of the positive electrode piece and battery of the present example includes the following steps:
(1) 4.6474 kg of nano-sized Co(OH)₂ particle powder and 5.0981 kg of nano-Al₂O₃ powder were weighted; the two materials were mixed in a high-speed mixer at a speed of 1500 rpm/min for 15 min; the mixture was then put into a muffle furnace and sintered at a set sintering temperature of 900° C. for 7 h, and then Al₂CoO₄ with a particle diameter of <3 μm was obtained;
(2) the aluminum-containing compound Al₂CoO₄ (D₅₀<3 μm) synthesized by the above high-temperature solid phase method and commercially available nano-Al₂O₃ powder, conductive agent SP and binder 5130 glue were mixed at a weight ratio of 20%:65%:4.5%:10.5%, and the mixture was dispersed in NMP, then a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 5 μm, and a surface density of the coating is 0.56 mg/cm², then a positive electrode piece 100 containing a safety layer 120 was obtained;
(3) lithium cobalt oxide Li_{1.003}Co_{0.960}Al_{0.021}Mg_{0.014}La_{0.005}O₂, polyvinylidene fluoride (PVDF), and carbon nanotube were mixed at a weight ratio of 97.2%:1.4%:1.4%, and the mixture was dispersed in NMP, then an active substance layer slurry was obtained after stirring by a double planetary stirrer; the active substance layer slurry was coated on surfaces of the positive electrode piece 100 containing the safety layer 120, and dried after coating, where a thickness of the coating layer on each side is about 80 μm, and a surface density of the coating is 17.82 mg/cm², and then a positive electrode piece 100 was obtained;
(4) the obtained positive electrode piece 100 was subjected to roll pressing to achieve a compacted density of 3.95 g/cm³; the positive electrode piece 100 after rolling pressing was subjected to a surface resistance test and the test values were recorded;
(5) graphite as negative active substance, styrene butadiene rubber (SBR), sodium carboxymethylcellulose, and conductive carbon black were mixed at a weight ratio of 94%:3%:2%:1%, and the mixture was dispersed in water, then a negative electrode slurry was obtained after mixing by a double planetary mixer; the negative electrode slurry was coated on surfaces of both sides of a copper foil current collector, and then subjected to roll pressing and drying to obtain a negative electrode piece for later use.

An electrolyte used includes a solvent and a lithium salt, where the solvent includes ethylene carbonate (EC), diethyl carbonate (DEC), propylene carbonate (PC), or fluoroethylene carbonate (FEC), and the lithium salt includes lithium hexafluorophosphate (1M). The electrolyte also includes a substance T as an additive. T is 4-methyl-1,3-propane sultone (4-methyl-1,2-oxathiolane 2,2-dioxide), its chemical structural formula is

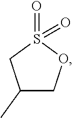

and its content accounts for 0.1-10% of a total content of the electrolyte.

Then, a wound core was obtained by winding, and packaged in an aluminum-plastic bag, then injected with the electrolyte, and after a hot pressing formation, a soft-pack battery cell was obtained, which was tested to have a capacity of 4300 mAh.

A capacity retention rate of the soft-pack battery cell in each cycle was measured, and its internal resistance change rate during cycle process, acupuncture performance and heavy object impact performance were tested.

### Comparative Example 1

The preparation method of the positive electrode piece and battery of Comparative Example 1 includes the following steps:
where, the preparation method of Comparative Example 1 differs from Example 1 in that steps (1) and (2) in Example 1 are omitted, that is to say, the positive electrode piece 100 only has the active substance layer 130 and does not include the safety layer 120. Other steps of the preparation method of Comparative Example 1 are the same as those of Example 1.

### Comparative Example 2

The preparation method of the positive electrode piece and battery of Comparative Example 2 includes the following steps:
where, the preparation method of Comparative Example 2 differs from Example 1 in that step (1) in Example 1 is omitted, and step (2) of Comparative Example 2 is: commercially available LiFePO₄ (D₅₀<3 μm), conductive agent SP and binder 5130 glue were mixed at a weight ratio of 85%:4.5%:10.5%; the mixture was dispersed in NMP and a safety layer slurry was obtained after stirring by a double planetary stirrer; the safety layer slurry was coated on surfaces of front and back sides of an aluminum foil current collector with a thickness of 12 μm, and dried after coating, where a thickness of the coating layer on each side is 5 μm, and a surface density of the coating is 0.56 mg/cm², then a positive electrode piece 100 containing a safety layer 120 was obtained. Other steps of the preparation method of Comparative Example 2 are the same as those of Example 1.

TABLE 1

| | | Internal | | | | | Surface |
|---|---|---|---|---|---|---|---|
| | Capacity | resistance | | | | | resistance |
| | retention | change | | | Theoretical | Actual | value of |
| | rate after | rate after | | Heavy | mass ratio | mass ratio | positive |
| | 400 | 400 | | object | of Co/Al in | of Co/Al in | electrode |
| Experimental | cycles | cycles | Acupuncture | impact | electrode | electrode | piece |
| group | (%) | (%) | test | test | piece | piece | (Ω*cm) |
| Example 1 | 89.12% | 45.67% | 18/20 pass | 19/20pass | 41.61 | 40.92 | 928 |
| Example 2 | 88.93% | 44.71% | 19/20 pass | 19/20pass | 41.61 | 41.04 | 1003 |
| Example 3 | 88.23% | 43.09% | 18/20 pass | 18/20pass | 63.72 | 62.75 | 1081 |
| Example 4 | 91.10% | 37.89% | 16/20 pass | 17/20pass | 49.82 | 49.31 | 573 |
| Example 5 | 87.85% | 51.83% | 20/20 pass | 20/20pass | 33.44 | 33.51 | 1560 |
| Example 6 | 93.12% | 37.46% | 18/20 pass | 19/20pass | 37.20 | 36.93 | 672 |
| Example 7 | 88.03% | 44.65% | 17/20 pass | 17/20pass | 43.51 | 43.23 | 1240 |
| Example 8 | 90.12% | 43.71% | 19/20 pass | 19/20pass | 39.27 | 38.91 | 993 |
| Example 9 | 91.53% | 39.09% | 19/20 pass | 19/20pass | 37.81 | 37.69 | 945 |
| Example 10 | 92.29% | 41.48% | 17/20 pass | 18/20pass | 55.38 | 55.4 | 657 |
| Example 11 | 88.18% | 47.63% | 20/20 pass | 20/20pass | 35.09 | 34.89 | 1683 |
| Example 12 | 87.06% | 49.75% | 20/20 pass | 20/20pass | 30.88 | 30.78 | 1730 |
| Comparative | 95.48% | 34.87% | 6/20 pass | 7/20pass | NA | NA | 359 |
| Example 1 | | | | | | | |
| Comparative | 85.78% | 64.38% | 17/20 pass | 18/20pass | NA | NA | 1978 |
| Example 2 | | | | | | | |

According to Table 1, specifically, from comparison between Examples 1-12 and Comparative Examples 1-2, it can be seen that the design of the safety layer 120 has significantly improved safety performance of the electrode piece, but the material composition and coating thickness of the safety layer 120 have a certain impact on the safety performance; compared with the currently commonly used lithium iron phosphate materials, the aluminum-containing compound used in the present application basically maintains a comparable level in terms of safety performance, but significantly improves the cycle performance and the internal resistance change rate during cycle process. When the mass ratio of Co and Al elements in the safety layer 120 and the active substance layer 130 in the positive electrode piece, as detected by ICP, is maintained within a certain range, the positive electrode piece has excellent safety performance.

Finally, it should be noted that the above examples are only used to illustrate the technical solutions of the present application, but not to limit them; although the present application has been described in detail with reference to the foregoing examples, those of ordinary skill in the art should understand that: the technical solutions described in the foregoing examples can still be modified, or some or all of the technical features therein can be equivalently replaced; and these modifications or replacements do not make the essence of the corresponding technical solutions deviate from the scope of the technical solutions of the examples of the present application.

What is claimed is:

1. A positive electrode piece, comprising a positive electrode current collector, a safety layer and an active substance layer, wherein the safety layer is arranged on a surface of the positive electrode current collector, and the active substance layer is arranged on a surface of the safety layer;
both the safety layer and the active substance layer contain Co and Al, wherein a mass ratio of a total amount of Co to a total amount of Al in the safety layer and the active substance layer is (12-85):1.

2. The positive electrode piece according to claim 1, wherein the mass ratio of the total amount of Co to the total amount of Al in the safety layer and the active substance layer is (25-65):1.

3. The positive electrode piece according to claim 1, wherein the safety layer comprises a filler, a first conductive agent and a first binder, and the filler, the first conductive agent and the first binder are mixed with each other, and the filler comprises an aluminum-containing compound;
the active substance layer comprises a positive electrode active substance, a second conductive agent and a second binder, and the positive electrode active substance, the second conductive agent and the second binder are mixed with each other.

4. The positive electrode piece according to claim 1, wherein a thickness of the safety layer is 1-10 μm.

5. The positive electrode piece according to claim 1, wherein a mass of the aluminum-containing compound is 70-96% of a mass of the safety layer.

6. The positive electrode piece according to claim 1, wherein the aluminum-containing compound has a chemical formula of Co(II)ₓ₁Co(III)ₓ₂Al_{y}O_{z}, which satisfies 2x₁+3x₂+3y=2z;
wherein x₁, x₂, y, z are all positive integers; and/or,
x₁ or x₂ is 0.

7. The positive electrode piece according to claim 6, wherein the aluminum-containing compound is Al₂Co(II)O₄ or AlCo(II) Co(III)O₄.

8. The positive electrode piece according to claim 3, wherein the filler further comprises at least one of carbon and cobalt oxide.

9. The positive electrode piece according to claim 3, wherein a mass ratio of the second conductive agent to the second binder in the active substance layer is in a range of (0.5-2):1.

10. A battery, comprising a negative electrode piece, a separator and the positive electrode piece according to claim 1, the separator being disposed between the positive electrode piece and the negative electrode piece.
